(19) United States
(12) Patent Application Publication
(10) Pub. No.: US 2003/0147242 A1
(43) Pub. Date: Aug. 7, 2003

(54) White LED array

(75) Inventor: James L. Stopa, Old Saybrook, CT (US)

Correspondence Address: ALIX YALE & RISTAS LLP, 750 MAIN STREET, SUITE 1400, HARTFORD, CT, 06103, US

(73) Assignee: Whelen Engineering Company, Inc.

(21) Appl. No.: 10/352,263

(22) Filed: Jan. 27, 2003

Related U.S. Application Data
(60) Provisional application No. 60/354,144, filed on Feb. 4, 2002.

(51) Int. Cl. F21V 9/00

(52) U.S. Cl. 362/231; 362/240

(57) ABSTRACT

An LED array is disclosed that provides white light having a warm hue by combining yellow LEDs and white LEDs in the array. The yellow LEDs are typically less expensive than the white LEDs, thereby improving the cost-efficiency of the LED array. A preferred ratio of one yellow LED for every two white LED is disclosed.

### BACKGROUND OF THE INVENTION

This invention relates generally to LED arrays, such as may be employed, for example, in emergency warning light systems. This invention also relates to LED arrays, which are employed generally for illumination purposes.

White LEDs are typically manufactured by using a blue LED as a base light source which emits short wavelength energy between 450 and 470 nm. A YAG phosphor covers the blue light source at the inside of the optic lens. When excited by the short wavelength energy, the phosphor emits a broadband energy in the form of white light. This optical concept is analogous to a fluorescent light which employs a mercury arc for the short wavelength energy and fluorescence on the inside of the tube for the broadband converter.

The use of white LEDs for illumination purposes has two significant problems. First, the hue of white light typically produced by a white LED is extremely harsh or tends to be bluish in color. This bluish hue causes objects to take on a greenish tint when illuminated at night. In addition, the typical white light is very harsh to the human eye. As an analogous consideration, this harshness is the principal rationale fluorescent bulbs are not typically employed in living areas for illumination. By contrast, a warmer yellow/white hue is a much better for color rendering and is more comfortable to the eyes.

A second problem associated with white LEDs is the cost. For example, white LEDs typically cost over three times the cost of a red or yellow LED. Accordingly, a white LED lamp is relatively quite costly compared to its incandescent counterpart.

### SUMMARY OF THE INVENTION

Briefly stated, the invention in a preferred form is an array of LEDs which include both white LEDs and yellow LEDs. The LEDs collectively produce a hue of light that is warmer and more similar to the hue of light produced by an incandescent bulb than a conventional cluster of only white LEDs. In one preferred embodiment, the ratio of one yellow LED to two white LEDs produces a very favorable hue of white light.

An object of the invention is to provide a new and improved LED array, which produces a warmer white hue and is less harsh to the eyes.

Another object of the invention is to provide a new and improved white LED array, which is less expensive than conventional arrays of only white LED arrays.

Other objects and advantages of the invention will become apparent from the drawing and the specification.

### BRIEF DESCRIPTION OF THE DRAWINGS

FIG. 1 is an exploded view of an illumination module which has a representative array of LEDs for a LED array which produces a “white” hue;

FIGS. 2a, 2b and 2c are top plan views, partly in schematic, of an illumination module base and representative arrays which may be employed in the present invention; and

FIG. 3 is a chromaticity chart illustrating representative chromatic characteristics of one LED array embodiment employing a white LED and an associated yellow LED.

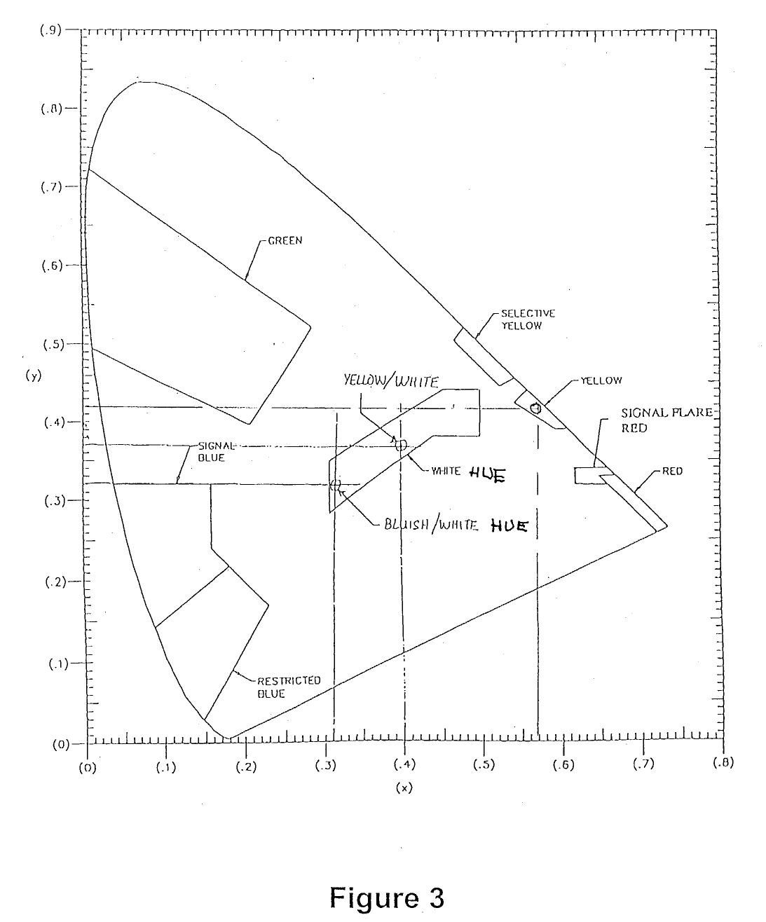

### DETAILED DESCRIPTION OF THE PREFERRED EMBODIMENT

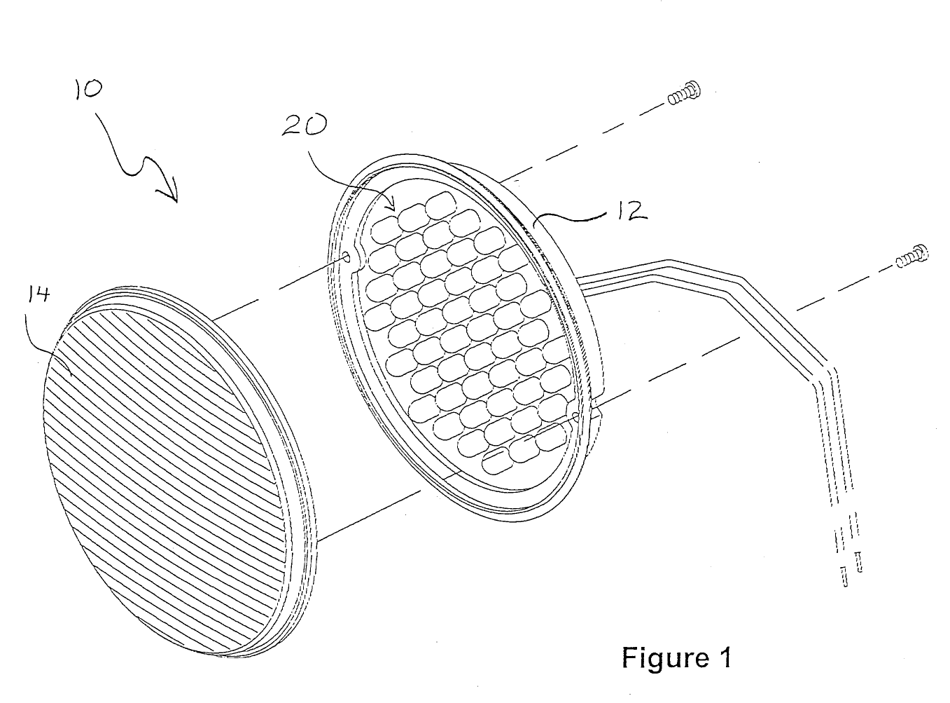

With reference to FIG. 1, an illumination module 10 comprises a base 12 and lens cover 14 which mounts to the base. The lens cover 14 preferably includes ribs or other structures to spread the light. The base 12 supports an LED array 20 which provides the “white” illumination. The LED array 20 is composed of both white LEDs 30 and yellow LEDs 40. The array 20 of LEDs collectively produce a “white” hue. In accordance with the invention, the yellow LEDs 40 are selectively positioned within the array. The majority of the LEDs are preferably white LEDs 30. It has been found that a ratio of one yellow LED 40 to two white LEDs 30 appears to provide the best results. However, other LED ratios can be suitably configured to provide a composite LED array 20 which produces a warm hue of light that is typically less harsh and does not have a bluish-type characteristic of a typically all-white LED array.

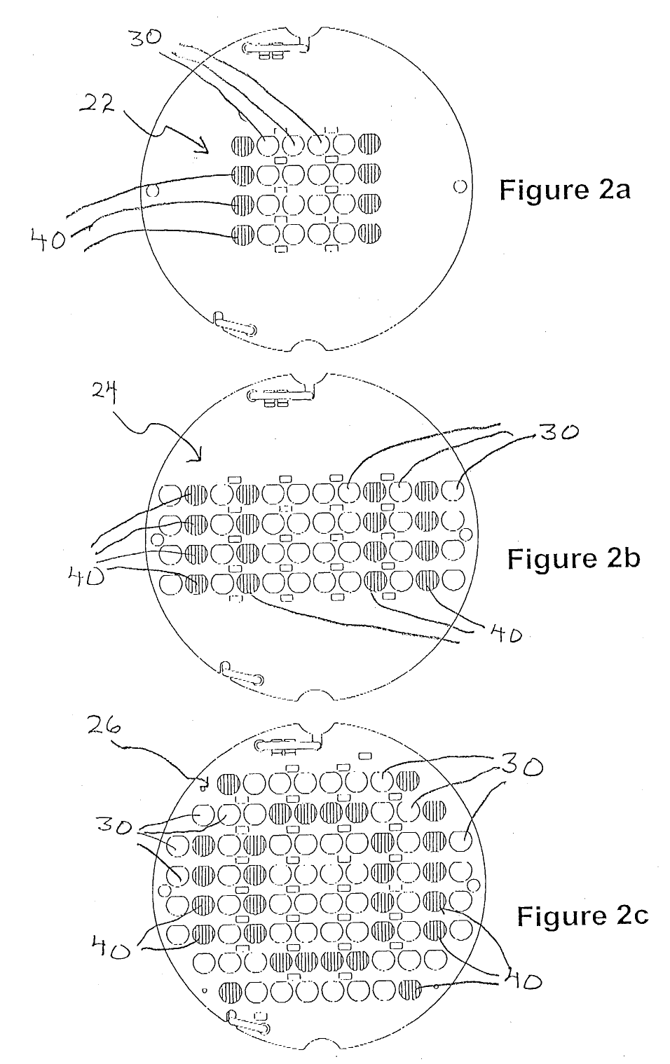

With reference to FIGS. 2a, 2b and 2c, various different representative arrays 22, 24 and 26, respectively, are illustrated to show and suggest various suitable configurations of LED arrays having white LEDs 30 and yellow LEDs 40. For each of the representative arrays, the ratio of yellow LEDs to white LEDs is 1 to 2. Stated differently, the ratio of yellow LEDs to all the LEDs employed in each array is 1 to 3. Each of the illustrated LED arrays provide a composite illumination which produces a white hue having the desired warm illumination characteristic.

The resulting light characteristics are the function of the difference of color temperature between each of the LEDs as well as the difference of intensity of each LED. The described LED ratio is effective when a white LED with a chromaticity center tolerance of approximately X=0.31 and Y=0.32 and an intensity of approximately 6 candelas at 15° viewing angles is associated with a 592 nm yellow LED with a chromatically of approximately X=0.57 and Y=0.42 producing 6 candelas at 15° viewing angles. The composite white/yellow LED array produced a chromaticity center tolerance of approximately X=0.4 and Y=0.37 as illustrated in FIG. 2.

It should be appreciated that in arrays which may employ a large number of white LEDs, the savings by employing the relatively less expensive yellow LEDs can be significant.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. An illumination array comprising a first plurality of yellow LEDs and a second plurality of white LEDs, wherein the LEDs cooperate to provide a light output having a warm white hue.

2. The illumination array of claim 1, wherein a ratio of yellow LEDs to white LEDs is 1 to 2.

3. The illumination array of claim 1, wherein the white LEDs have a chromaticity center tolerance of substantially X=0.31 and Y=0.32 and produce an intensity of approximately 6 candelas at a 15° viewing angle.

4. The illumination array of claim 1, wherein the yellow LEDs emit light having a wavelength at 592 nm and a chromaticity center tolerance substantially of X=0.57 and Y=0.42 and produce an intensity of approximately 6 candelas at a 15° viewing angle.

5. The illumination array of claim 1, wherein the array produces a chromaticity center tolerance substantially of X=0.4 and Y=0.37.

6. A method for constructing an LED array having a warm white hue comprising the steps of:
arranging a first plurality of yellow LEDs in an array;
arranging a second plurality of white LEDs adjacent the yellow LEDs in the array.

7. The method of claim 6, wherein a ratio of a number of yellow LEDs in said first plurality to a number of white LEDs in said second plurality is 1 to 2.
